(19) United States
(12) Patent Application Publication
(10) Pub. No.: US 2026/0012235 A1
(43) Pub. Date: Jan. 8, 2026

(54) SPECTRAL EFFICIENCY USING CANONICAL CORRELATION ANALYSIS

(71) Applicant: TRABUS, San Diego, CA (US)

(72) Inventors: Roy Franklin Quick, San Diego, CA (US); Nicholas Woolsey, San Diego, CA (US); Arthur Salindong, San Diego, CA (US)

(21) Appl. No.: 19/259,646

(22) Filed: Jul. 3, 2025

Related U.S. Application Data
(60) Provisional application No. 63/668,579, filed on Jul. 8, 2024.

(51) Int. Cl. H04B 7/0456; H04B 7/06; H04B 7/08

(52) U.S. Cl. CPC H04B 7/0456; H04B 7/0667; H04B 7/0854

(57) ABSTRACT

Modifying signals so that the signals are differentiated for spectral efficiency, including: modifying the signals wherein a first signal is correlated between first and second transmissions and a second signal is uncorrelated between the first and second transmissions; transmitting the first and second signals with time delays from a plurality of antennas; and receiving and finding a set of weights corresponding to the plurality of antennas, wherein correlation between two transmissions is maximized.

### CROSS-REFERENCE TO RELATED APPLICATIONS

This application claims the benefit of priority under 35 U.S.C. § 119(e) of co-pending U.S. Provisional Patent Application No. 63/668,579, filed Jul. 8, 2024, entitled “Spectral Efficiency using Canonical Correlation Analysis”. The disclosure of the above-referenced application is incorporated herein by reference.

### BACKGROUND

### Field of the Invention

The present disclosure relates generally to canonical correlation analysis, and more specifically, to using canonical correlation analysis to maximize the correlation between signal sets while discarding correlations between antennas within the sets.

### Description of the Related Art

Canonical correlation analysis (CCA) is a technique in a family of statistical techniques that includes analysis of variance. The statistical techniques use correlation matrices estimated over multiple measurements to determine the main factors contributing to the correlation. The CCA seeks to analyze the correlation between two sets of measurements, whereas analysis of variance only considers correlations within a single set of measurements.

For application of these techniques to communication, measurements are considered to be time samples of received signals on the receiving antennas. For the use of CCAs, two sets of measurements may be obtained from different orthogonal sets of signals received through the same set of antennas. For example, signals may be orthogonal by being sent during different time intervals, where the same desired signal is transmitted in each interval. Other methods of creating orthogonal signals are by transmission in two different frequency bands and by using different sets of orthogonal basis functions, for example, as in Code Division Multiple Access (CDMA). The repetition introduces a correlation between the measurement sets due to the desired signal, whereas noise and interference would be uncorrelated between the sets. However, both the signal and the noise/interference would be correlated between antennas in the same set. The CCA seeks to maximize the correlation between signal sets while discarding correlations between antennas within the sets.

If there are enough antennas to capture the full rank of the received signal, the CCA will provide a set of antenna gains and phase weights that null out interference, thereby maximizing the desired signal. Typically, the signal rank is the number of all signals (including noise/interference) times the number of multipath delays.

Prior methods of removing interference have involved similar techniques of applying antenna weights to null out the interfering signals. Typically, the weights produce an effective antenna pattern that has a null in the direction of each interferer. This method is often called “null steering”. This requires knowing the directions to the interferers and determining weights that place the nulls in those directions. Thus, these methods require a calibrated antenna array that can estimate direction and allow direct application of the calculated weights.

### SUMMARY

In one implementation, a method of modifying signals so that the signals are differentiated for spectral efficiency is disclosed. The method includes: modifying the signals wherein a first signal is correlated between first and second transmissions and a second signal is uncorrelated between the first and second transmissions; transmitting the first and second signals with time delays from a plurality of antennas; and receiving and finding a set of weights corresponding to the plurality of antennas, wherein correlation between two transmissions is maximized.

In another implementation, a method for determining antenna weights for reception of data using transmitters and receivers is disclosed. The method includes: receiving first and second signals including uncorrelated noise and interference over first and second intervals, wherein the first and second signals are uncorrelated over the first and second intervals for all transmitters; modifying the second signal by applying a circular shift by enough samples that a resultant signal is uncorrelated with the first signal; forming measurements for a first measurement as a sum of the first signals and a second measurement as a sum of the second signals; determining the antenna weights for the first and second measurements using CCA; and applying the antenna weights to the received first and second signals and decoding the data.

In a further implementation, a method for applying CCA for MIMO signaling is disclosed. The method includes: establishing a coordination between a transmitter and a receiver, wherein the receiver provides an estimated channel rank and recommended antenna weights; establishing another coordination between the transmitter and the receiver to inform the receiver about a number of signals that is being sent and a pre-coding; and transmitting the signals from the transmitter, but from multiple different antennas using the recommended antenna weights for each signal.

Other features and advantages should be apparent from the present description which illustrates, by way of example, aspects of the disclosure.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 is a flow diagram showing a method of modifications made to signals so that the CCA can differentiate between them by making two sets of measurements in accordance with the first implementation of the present disclosure;

FIG. 2 is a flow diagram illustrating a method for determining antenna weights for data reception in accordance with one implementation of the present disclosure;

FIG. 3 is a flow diagram of a method for applying CCA for MIMO signaling in accordance with one implementation of the present disclosure;

FIG. 4A is a flow diagram of a method for using the CCA for MIMO signaling in accordance with one implementation of the present disclosure; and

FIG. 4B is a flow diagram of a method for using the CCA for MIMO signaling in accordance with another implementation of the present disclosure.

### DETAILED DESCRIPTION

As described above, prior methods of removing interference have involved similar techniques of applying antenna weights to null out the interfering signals. Typically, the weights produce an effective antenna pattern that has a null in the direction of each interferer. This method is often called “null steering”. This requires knowing the directions to the interferers and determining weights that place the nulls in those directions. Thus, these methods require a calibrated antenna array that can estimate direction and allow direct application of the calculated weights.

Certain implementations of the present disclosure provide for calculating the “null steering” weights using CCA and without requiring a calibrated antenna array, but with a repeated desired signal. In one implementation, the CCA is able to calculate the weights without any knowledge about the signals, but only that the desired signal is repeated. Accordingly, the described implementations provide advantages in commercial applications where the cost and size of the calibrated antenna arrays is prohibitive. The appendix describes the details of the CCA technique of the implementations of the present disclosure.

After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In some implementations, the CCA is used to provide spectral efficiency in which the same channel is used to enable simultaneous transmission of more than one signal.

In a first implementation, signals from multiple transmitters are transmitted to one receiver or multiple receivers.

In a second implementation, multiple signals from one transmitter are transmitted to one receiver (a technique referred to as Multiple Input Multiple Output (MIMO)).

In both implementations, having simultaneous signals using the same repetition intervals would cause the signals to be correlated between the intervals. Therefore, without some modifications to the signals, the CCA would not be able to distinguish the signals or to separate them so that each signal can be decoded without interference from the others. The descriptions below describe the modifications to the transmitted signals that would enable the separation of the signals.

In the first implementation, simultaneous transmissions of signals are made from multiple sources. An advantage of this implementation is that the signals arrive at the receiving antenna array from multiple different directions. Thus, the signals may be relatively easily separated using null steering to suppress all but one of the signals (including multipath delays). To do this, the received measurements are modified as they are input to the CCA so that all signals except one are treated as interference.

For the first implementation, there are two necessary prerequisites:

There must be coordination of transmit timing in order for the signals to be sent simultaneously. It is assumed that the transmitters are part of a network that provides time synchronization as a service, and that the transmissions occur in time slots defined by the synchronization protocol.

In such a network, signaling to control which transmitters send and which receive must be established. In Time Division Duplexing (TDD) systems, units cannot send and receive at the same time. Other limitations on the number of simultaneous transmissions may exist due to the number of antennas available. A suitable function in a control channel should transmit broadcast information one unit at a time to the other units.

Repetition in the control channel is used to obtain measurements that will be used for the CCA to determine the best weights during data reception.

For the first implementation, modifications are made to the signals so that the CCA can differentiate between them by making two sets of measurements. In one implementation, a signal is transmitted twice but with time delays. The CCA then finds a set of weights on the antennas (phasing of the antennas) such that the correlation between the two transmissions is maximized. Noise and interference will be correlated between the antennas (i.e., antenna to antenna) because antennas receive everything. However, only the desired signal will be correlated from time interval to time interval. The CCA computes antenna weights to retain the desired signal but remove everything else including the noise and interference. The CCA cannot differentiate between two repeated signals transmitted at the same time, but it can distinguish the signals if only one signal is correlated between the first and second transmissions. Accordingly, modifications to the signals are made in such a way that one signal is correlated between the first and second transmissions, and the other signal is uncorrelated between the first and second transmissions. To make a signal (including a first half and a second half) uncorrelated, a modification is made to the second half to make it uncorrelated with the first half. To make the modifications, in one implementation, the second half of one of the signals is shifted in time. In this implementation, it is advantageous to include a cyclic prefix before the second half. As is well known, a cyclic prefix is a repetition of samples from the last part of a signal so that a cyclic time shift can be used. A cyclic time shift preserves the full signal content after the shift, whereas some of the signal content is lost in a non-cyclic shift. In another implementation, the second half of one of the signals is shifted in frequency by multiplying the signal by a sine wave.

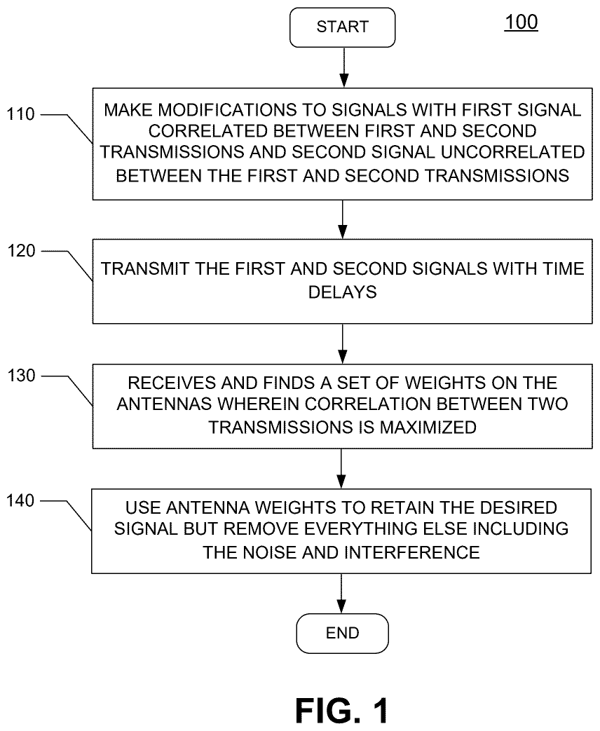

FIG. 1 is a flow diagram showing a method 100 of modifications made to signals so that the CCA can differentiate between them by making two sets of measurements in accordance with the first implementation of the present disclosure. Initially, modifications are made, at step 110, to the signals in such a way that first signal is correlated between the first and second transmissions, and second signal is uncorrelated between the first and second transmissions. In one implementation, each signal includes a first half and a second half. In one implementation, to make the signals uncorrelated, modifications are made to the second half to make it uncorrelated with the first half. For example, in one implementation, the second half of is shifted in time with respect to the first half. In this implementation, it is advantageous to include a cyclic prefix before the second half, which is a repetition of samples from the last part of a signal so that a cyclic time shift can be used. A cyclic time shift preserves the full signal content after the shift, whereas some of the signal content is lost in a non-cyclic shift. In another example, the second half of one of the signals is shifted in frequency by multiplying the signal by a sine wave.

In one implementation, the first and second signals are transmitted, at step 120, with time delays. At step 130, the CCA then receives and finds a set of weights on the antennas (phasing of the antennas) such that the correlation between the two transmissions is maximized. Noise and interference will be correlated between the antennas (i.e., antenna to antenna) because antennas receive everything. However, only the desired signal will be correlated from time interval to time interval. The CCA uses antenna weights, at step 140, to retain the desired signal but remove everything else including the noise and interference. The CCA cannot differentiate between two repeated signals transmitted at the same time, but it can distinguish the signals if only one signal is correlated between the first and second transmissions.

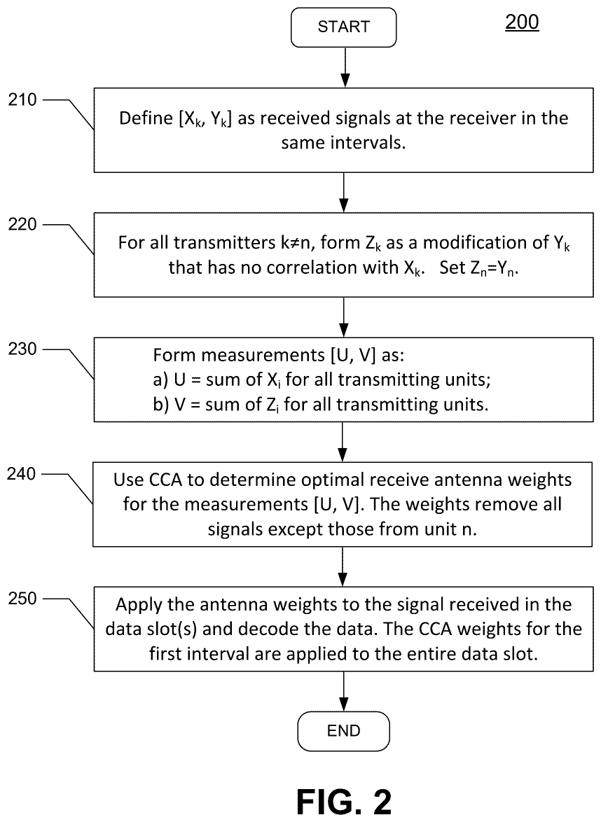

FIG. 2 is a flow diagram illustrating a method 200 for determining antenna weights for data reception in accordance with one implementation of the present disclosure. In one implementation, the control channel transmission for unit k includes two transmissions of signal Cₖ, denoted as [Cₖ, Cₖ]. At step 210, the received signals at the receiver in the same intervals are defined as [Xₖ, Yₖ]. The received signals are not identical in the two intervals because of uncorrelated noise and interference. In the control channels, the CCA is used to separate the desired signal from interferences, which is advantageous for reception of the control messages. Further, the received signals are stored by the receiver for later use during data reception. In one implementation, the control protocol determines which transmitters will send in a later data slot using control messages. The receiver of the data transmission from unit n uses the saved control signals to determine the antenna weights for data reception.

In the illustrated implementation of FIG. 2, Zₖ is formed, at step 220, as a modification of Yₖ that has no correlation with Xₖ, for all transmitters k≠n. Also, Zₙ is set equal to Yₙ. In one example, Zₖ is a circular shift of Yₖ by enough samples that the result is uncorrelated with Xₖ. If Cₖ has good autocorrelation properties, any nonzero shift would suffice. In the presence of multipath, the shift should be larger to prevent causing delayed paths to create a correlation. The amount of shift must be different for each k. In another example, Zₖ is Yₖ times a complex exponential exp(jwt), where w is chosen so that the complex exponential is periodic over the time interval of Yₖ. The exponential may repeat any integer number of times during the interval. Further, the frequency w must be different for each k.

Measurements [U, V] are formed, at step 230, as: (a) U=sum of Xᵢ for all transmitting units; and (b) V=sum of Zᵢ for all transmitting units. The CCA is used, at step 240, ti determine optimal receive antenna weights for the measurements [U, V]. These weights remove all signals except for those from unit n. The antenna weights are then applied, at step 250, to the signal received in the data slot(s) and decode the data. The signal in a data slot does not have to be repeated. The CCA weights for the first interval may be applied to the entire data slot.

In the second implementation involving MIMO, the signals are alternatively modified prior to the transmission. However, the signals require coordinating the changes across the transmitters and receivers so that the receivers may decode the signals. Such coordination is more feasible if the signals are sent by the same transmitter.

In MIMO, all signals are sent from the same source, but they are sent from multiple antennas using different transmit antenna weights (referred to as pre-coding) for each signal. Thus, for MIMO, following prerequisites must be adhered to: (a) there must be coordination between the transmitter and the receiver, in which the receiver provides an estimated channel rank and recommended pre-coding; and (b) similar coordination is needed for the transmitter to inform the receiver about the number of signals that is being sent and the actual pre-coding.

Regarding (a), the coordination is needed because the receiver has the capability to measure the channel, while the transmitter does not. Thus, the transmitter operating within a predetermined control protocol uses the information to determine the number of signals to send and how to pre-code the signals.

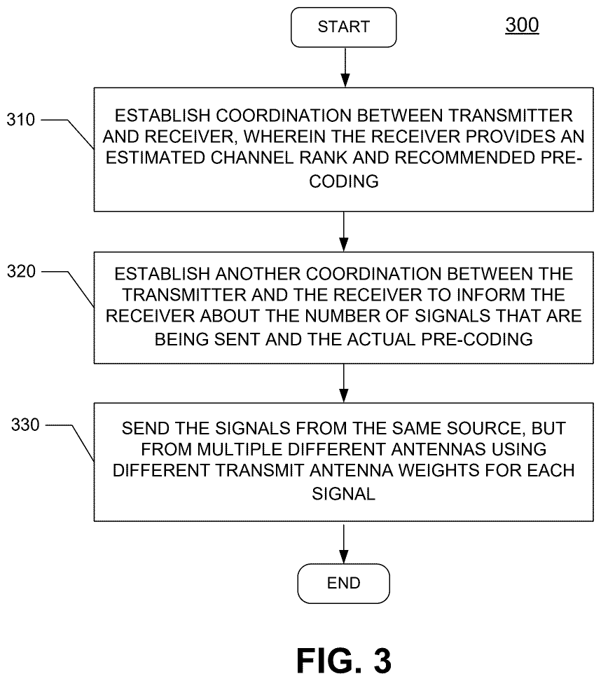

FIG. 3 is a flow diagram of a method 300 for applying CCA for MIMO signaling in accordance with one implementation of the present disclosure. In one implementation, signals are modified prior to the transmission, wherein the signals require coordinating the changes across the transmitters and receivers so that the receivers may decode the signals. Such coordination is more feasible if the signals are sent by the same transmitter.

In the illustrated implementation of FIG. 3, a coordination is established, at step 310, between the transmitter and the receiver, in which the receiver provides an estimated channel rank and recommended pre-coding. In one implementation, the coordination is needed because the receiver has the capability to measure the channel, while the transmitter does not. Thus, the transmitter operating within a predetermined control protocol uses the information to determine the number of signals to send and how to pre-code the signals. Another coordination is established, at step 320, between the transmitter and the receiver to inform the receiver about the number of signals that is being sent and the actual pre-coding. The signals are then sent, at step 330, from the same source, but from multiple different antennas using different transmit antenna weights (referred to as pre-coding) for each signal.

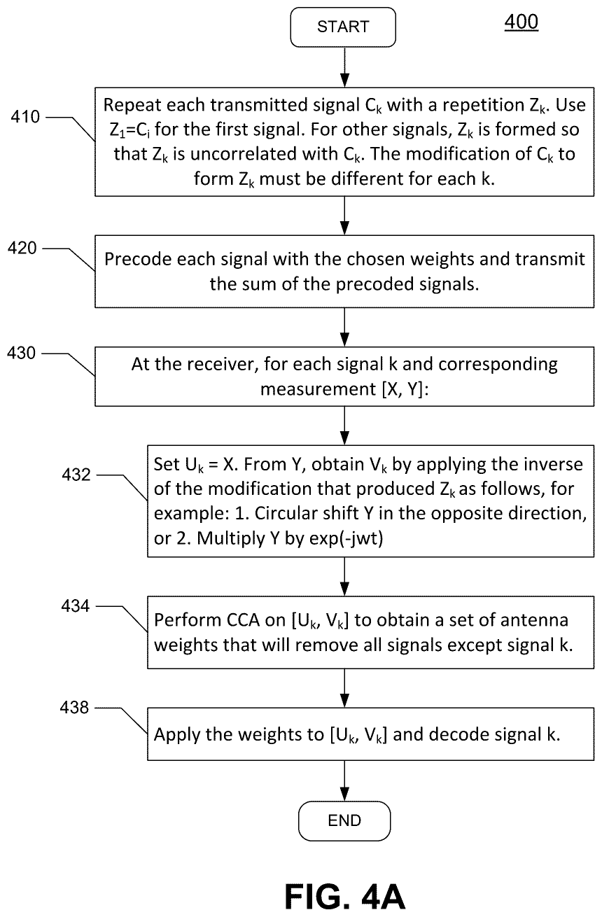

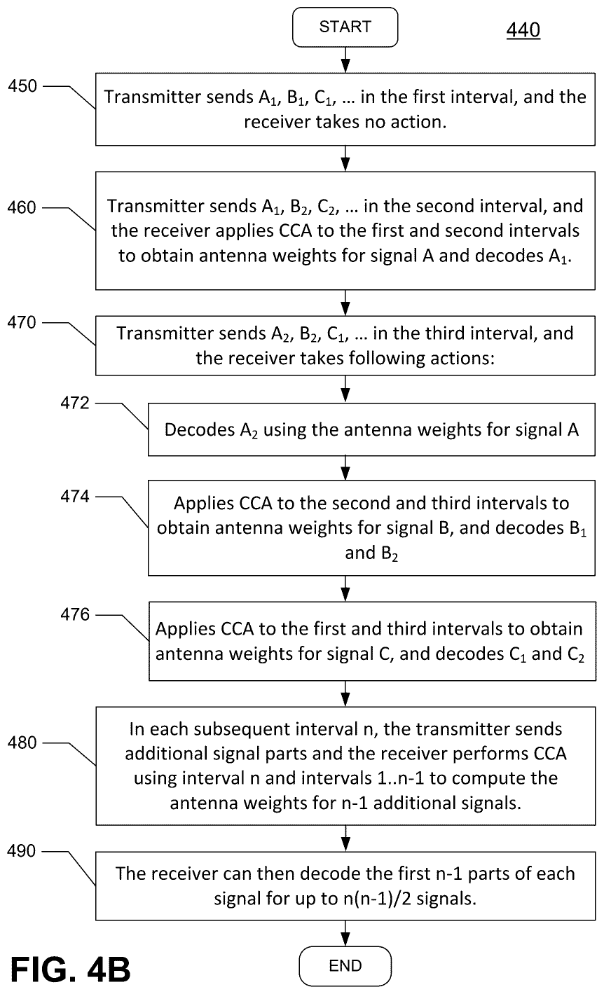

FIGS. 4A and 4B present two detailed implementations of using the CCA for MIMO signaling in accordance with the second implementation of the present disclosure.

FIG. 4A is a flow diagram of a method 400 for using the CCA for MIMO signaling in accordance with one implementation of the present disclosure.

In the illustrated implementation of FIG. 4A, each transmitted signal Cₖ is repeated, at step 410, with a repetition Zₖ. The first signal may use Z₁=Cᵢ. For other signals, Zₖ is formed so that Zₖ is uncorrelated with Cₖ, for example using the methods described above. The modification of Cₖ to form Zₖ must be different for each k. Each signal is pre-corded with chosen weights and the sum of the pre-coded signals is transmitted, at step 420.

At the receiver, for each signal k and corresponding measurement [X, Y], as stated in step 430, following steps are taken. At step 432, Uₖ is set equal to X, and from Y, Vₖ is obtained by applying the inverse of the modification that produced Z. For the example modifications described above: (a) circular shift Y in the opposite direction; or (b) multiply Y by exp(−jwt). At step 434, CCA is performed on [Uₖ, Vₖ] to obtain a set of antenna weights that will remove all signals except signal k. The weights are then applied to [Uₖ, Vₖ] and signal k is decoded, at step 436.

FIG. 4B is a flow diagram of a method 440 for using the CCA for MIMO signaling in accordance with another implementation of the present disclosure. The method 440 does not require modification of signals but requires more transmissions. For example, a series of intervals in which signals A, B, C, . . . are sent with each signal having multiple parts Aₖ. In each interval, pre-code the selected signal parts, and transmit the sum of the pre-coded signal parts as follows.

In the illustrated implementation of FIG. 4B, the transmitter sends A₁, B₁, C₁, . . . in the first interval, and the receiver takes no action, at step 450. The transmitter sends A₁, B₂, C₂, . . . in the second interval, and the receiver applies CCA to the first and second intervals, at step 460, to obtain antenna weights for signal A and decode A₁. The transmitter then sends A₂, B₂, C₁, . . . , at step 470. The receiver decodes A₂ using the antenna weights for signal A, at step 472. The receiver also applies CCA to the second and third intervals to obtain antenna weights for signal B, and decode B₁ and B₂, at step 474. The receiver further applies CCA to the first and third intervals, at step 476, to obtain antenna weights for signal C, and decode C₁ and C₂. At step 480, in each subsequent interval n, the transmitter sends additional signal parts and the receiver performs CCA using interval n and intervals 1 . . . n−1 to compute the antenna weights for n−1 additional signals. The receiver then decodes, at step 490, the first n−1 parts of each signal for up to n (n−1)/2 signals.

In a particular implementation, a method of modifying signals so that the signals are differentiated for spectral efficiency is disclosed. The method includes: modifying the signals wherein a first signal is correlated between first and second transmissions and a second signal is uncorrelated between the first and second transmissions; transmitting the first and second signals with time delays from a plurality of antennas; and receiving and finding a set of weights corresponding to the plurality of antennas, wherein correlation between two transmissions is maximized.

In one implementation, each signal of the first and second signals includes a first half and a second half. In one implementation, modifying the signals comprises modifying the second half to make it uncorrelated with the first half to make a signal uncorrelated between first and second transmissions. In one implementation, making the signal uncorrelated between the first and second transmissions comprises shifting the second half in time with respect to the first half. In one implementation, the method further includes adding a cyclic prefix before the second half, wherein the cyclic prefix is a repetition of samples from last part of a signal so that a cyclic time shift is used. In one implementation, the cyclic time shift preserves full signal content after the shift. In one implementation, the cyclic time shift loses some signal content in a non-cyclic shift. In one implementation, making the signal uncorrelated between the first and second transmissions comprises shifting the second half of one of the signals in frequency by multiplying one of the signals by a sine wave. In one implementation, the set of weights comprises phasing of the antennas. In one implementation, the method further includes retaining desired signal but removing everything else including noise and interference using the set of antenna weights.

In another particular implementation, a method for determining antenna weights for reception of data using transmitters and receivers is disclosed. The method includes: receiving first and second signals including uncorrelated noise and interference over first and second intervals, wherein the first and second signals are uncorrelated over the first and second intervals for all transmitters; modifying the second signal by applying a circular shift by enough samples that a resultant signal is uncorrelated with the first signal; forming measurements for a first measurement as a sum of the first signals and a second measurement as a sum of the second signals; determining the antenna weights for the first and second measurements using CCA; and applying the antenna weights to the received first and second signals and decoding the data.

In one implementation, the method further includes determining which transmitters to use to send the data using control signals. In one implementation, applying the circular shift comprises applying a nonzero shift with autocorrelation properties. In one implementation, amount of the circular shift is different for each transmitter. In one implementation, the resultant signal is substantially equal to the second signal times a complex exponential exp (jwt), where w is chosen so that the complex exponential is periodic over a time interval of the second signal and the complex exponential is different for each transmitter. In one implementation, applying the antenna weights removes all signals except for those from a unit including the data.

In a further particular implementation, a method for applying CCA for MIMO signaling is disclosed. The method includes: establishing a coordination between a transmitter and a receiver, wherein the receiver provides an estimated channel rank and recommended antenna weights; establishing another coordination between the transmitter and the receiver to inform the receiver about a number of signals that is being sent and a pre-coding; and transmitting the signals from the transmitter, but from multiple different antennas using the recommended antenna weights for each signal.

In one implementation, the receiver has capability to measure a transmission channel, while the transmitter does not. In one implementation, the transmitter operating within a predetermined control protocol determines a number of signals to send and how to pre-code the signals.

The disclosed implementations are provided to enable any person skilled in the art to make or use the disclosure. Various modifications to these implementations will be readily apparent to those skilled in the art, and the generic principles described herein can be applied to other implementations without departing from the spirit or scope of the disclosure. Thus, it is to be understood that the description presented herein shows implementations representative of the subject matter which is broadly contemplated by the present disclosure.

Examples of implementations are shown on the following pages. All features of each example are not necessarily required in a particular implementation.

Additional variations and implementations are also possible. Accordingly, the technology is not limited only to the specific examples noted herein.

1. A method of modifying signals so that the signals are differentiated for spectral efficiency, the method comprising:
modifying the signals wherein a first signal is correlated between first and second transmissions and a second signal is uncorrelated between the first and second transmissions;
transmitting the first and second signals with time delays from a plurality of antennas; and
receiving and finding a set of weights corresponding to the plurality of antennas,
wherein correlation between two transmissions is maximized.

2. The method of claim 1, wherein each signal of the first and second signals includes a first half and a second half.

3. The method of claim 2, wherein modifying the signals comprises modifying the second half to make it uncorrelated with the first half to make a signal uncorrelated between first and second transmissions.

4. The method of claim 3, wherein making the signal uncorrelated between the first and second transmissions comprises shifting the second half in time with respect to the first half.

5. The method of claim 4, further comprising
adding a cyclic prefix before the second half,
wherein the cyclic prefix is a repetition of samples from last part of a signal so that a cyclic time shift is used.

6. The method of claim 5, wherein the cyclic time shift preserves full signal content after the shift.

7. The method of claim 5, wherein the cyclic time shift loses some signal content in a non-cyclic shift.

8. The method of claim 3, wherein making the signal uncorrelated between the first and second transmissions comprises shifting the second half of one of the signals in frequency by multiplying one of the signals by a sine wave.

9. The method of claim 1, wherein the set of weights comprises phasing of the antennas.

10. The method of claim 1, further comprising
retaining desired signal but removing everything else including noise and interference using the set of antenna weights.

11. A method for determining antenna weights for reception of data using transmitters and receivers, the method comprising:
receiving first and second signals including uncorrelated noise and interference over first and second intervals,
wherein the first and second signals are uncorrelated over the first and second intervals for all transmitters;
modifying the second signal by applying a circular shift by enough samples that a resultant signal is uncorrelated with the first signal;
forming measurements for a first measurement as a sum of the first signals and a second measurement as a sum of the second signals;
determining the antenna weights for the first and second measurements using CCA; and
applying the antenna weights to the received first and second signals and decoding the data.

12. The method of claim 11, further comprising determining which transmitters to use to send the data using control signals.

13. The method of claim 11, wherein applying the circular shift comprises applying a nonzero shift with autocorrelation properties.

14. The method of claim 11, wherein amount of the circular shift is different for each transmitter.

15. The method of claim 11, wherein the resultant signal is substantially equal to the second signal times a complex exponential exp (jwt), where w is chosen so that the complex exponential is periodic over a time interval of the second signal and the complex exponential is different for each transmitter.

16. The method of claim 11, wherein applying the antenna weights removes all signals except for those from a unit including the data.

17. A method for applying CCA for MIMO signaling, the method comprising:
establishing a coordination between a transmitter and a receiver, wherein the receiver provides an estimated channel rank and recommended antenna weights;
establishing another coordination between the transmitter and the receiver to inform the receiver about a number of signals that is being sent and a pre-coding; and
transmitting the signals from the transmitter, but from multiple different antennas using the recommended antenna weights for each signal.

18. The method of claim 17, wherein the receiver has capability to measure a transmission channel, while the transmitter does not.

19. The method of claim 17, wherein the transmitter operating within a predetermined control protocol determines a number of signals to send and how to pre-code the signals.
